(19) United States
(12) Patent Application Publication
(10) Pub. No.: US 2004/0090390 A1
(43) Pub. Date: May 13, 2004

(54) Method and system for controlling electronic content display

(76) Inventors: Philip Andrew Mason, St Leonards New South Wales (AU); James Ross McCoull, Rosebury New South Wales (AU)

Correspondence Address: GALLAGHER & DAWSEY CO., L.P.A., P.O. BOX 785, COLUMBUS, OH, 43216, US

(21) Appl. No.: 10/469,137

(22) PCT Filed: Feb. 27, 2002
(86) PCT No.: PCT/AU02/00211

(30) Foreign Application Priority Data
Feb. 27, 2001 (AU) PR 3404

(51) Int. Cl. G09G 5/00

(52) U.S. Cl. 345/1.1

(57) ABSTRACT

Content control programme 14 for electronic book system 10 includes an automatic shutdown feature 31 which issues a shutdown request 40 in response to the state of the display 65. Prior to shutdown, the system 10 enters a post read sequence 36 which is configurable by a user. The programme 14 also provides other enhanced functions including the control of access to supplemental information 34 by linking of that information to the book content 15, and the generation of lists 61 by selection of material on the display.

The present invention relates generally to electronic content and more specifically to systems and methods for controlling and utilising content for electronic books.

Advances in computer technology has substantially improved the accessibility of information. Improvements in display and content storage of computer systems, and communications, have provided an extremely efficient and powerful tool for the distribution of electronic information.

With the development in computer technology, an increasing number of users are obtaining and accessing reading material in electronic form. This trend has been driven by the emerging Internet and digital publishing technologies, and the growth of end user products such as PC and electronic book based display devices. Further, a reinvention of traditional book markets in the increased installation of electronic formats in computer resources in libraries and schools have also been a contributing force to the drive for the provision of electronic versions of reading material.

To replicate the experience of reading printed documents, the content for electronic books is ideally structured as discrete page images to provide a multiple page document which can be sequentially displayed on the display device. These page images typically include text and graphics, and can also be augmented by video and audio as required.

There is a continuing need to improve the functionality of the electronic content displays to enhance a user's experience. An aim of the present invention is to provide improved methods and systems for controlling electronic content displays so as to enable this enhanced functionality.

Accordingly, in a first aspect, the present invention provides a method of controlling the display of electronic book content on a display surface under operation of a content control programme, said book content including a plurality of page images which form a multiple page document and said display surface being capable of adopting an active mode where information can be displayed, and an inactive mode where the surface is substantially passive, said method including the steps of:

displaying at least one of said pages on said display surface whilst in its active mode;

generating a shut down request without requiring user intervention; and

rendering the display surface inactive in response to said shut down request.

Accordingly, this aspect of the present invention provides for an automatic display change where the display surface will become inactive after the book content, or a predetermined portion of it, has been displayed. In this way, the user is able to experience the presentation of the page images without having to worry to shut down the system once that presentation is completed. This functionality is ideally suited for bedtime reading where a user may fall asleep without shutting down the display, or as a system to enable the amount of material that is to be displayed at any one time to be controlled.

The display surface may be rendered inactive through controlling the computer system to fully shut down, or to move into a power save mode, sleep mode or an idle mode. The actual state of the computer display will depend on the functionality of the underlying computer system and the request made to that system.

In a particularly preferred form, the computer system has a user input, and the display is rendered inactive in response to an input by the user which is made prior to the display of the plurality of pages. In this way, this shut down functionality of the display can be provided as an option to the content display. Further, in a preferred form, the user is able to configure the system so that the display surface will be rendered inactive at a predetermined point in the display of the content.

Each page of the content may include text, and/or graphics, and may be augmented by video or audio. In one form, the text represented in the individual pages is narrated. Further, the pages may be displayed automatically, in the predetermined order and/or may be controlled manually by the user. Further, the predetermined order may be sequential, or may be pre-configured by a user to encompass selected parts of the book content.

In a particularly preferred form, the method further includes the steps of providing in electronic form, at least one post read sequence, and displaying the post read sequence after completion of the display of pages and prior to rendering the display surface inactive.

In a particularly preferred form, characteristics of the post read sequence are configurable by a user. These characteristics may include the specific images displayed, the intensity of the display, the duration of the post read sequence or the existence of other contents such as text or video.

The post read sequence may consist of sounds, music, or visuals and is designed to enrich the experience of the display such as by enriching the story reading process, or to encourage the user to enter a predetermined emotional state. Alternatively or additionally, the post read sequence may enable the display surface to have a secondary purpose such as providing an ambient light so that the display acts as a night light.

In yet a further aspect, the present invention provides a variation on the method described above where the display surface, under control of the computer system, is operative to change from its inactive mode to its active mode, and wherein a plurality of pages of the book content are displayed on the active display surface.

In this aspect, the method is preferably instigated by a previously made request of the user so that the system provides an automatic start up from a sleep, power save, or idle mode, thereby allowing the book content to be used as an alarm clock, reminder service, calendar or the like. Further, this method can be employed to enable predetermined scheduling of presentation of the book content which can be utilised for broadcast purposes, or to co-ordinate multiple presentations of the content.

In yet a further aspect, the present invention provides a book content programme for displaying information on a computer system including a display surface, the display surface being operative to adopt an active mode, where information can be displayed, and an inactive mode where the surface is substantially passive, the programme including electronic book content which includes a plurality of page images which form a multiple page document, and a controller including content control component to control the display of pages on the display surface, and display control component which is operative to request the computer system to change said display surface from said active mode to said passive mode, wherein the programme is configured so that the display control component is operative without user intervention to issue said request to said computer system to change from said active mode to said passive mode, after at least one page has been displayed on said display surface under control of said content control component.

In a preferred form, the display control component is able to be selectively enabled and disabled by a user input, and wherein the programme further includes an input component for allowing a user to enable said display control component prior to the display of said pages under control of the content control component.

Preferably, the programme further includes a post read content sequence, the post read content sequence being operative to be displayed on said display surface under operation of said content control component, when said display control component has been enabled. In this arrangement, the content control sequence is operative to be displayed following display of the pages, and prior to operation of the display control component to render the display screen inactive.

In a particularly preferred form, at least one characteristic of the post read content sequence is able to be configured by the user. These characteristics may include the specific images displayed, duration of the post read sequence, or the existence of other contents such as text or video to augment the post read sequence, or to vary the intensity of the display.

In a further aspect, the present invention relates to enhancing the functionality of electronic book content by the use of supplemental information.

In accordance with this aspect of the invention, there is provided a method of controlling the display of information on a display surface of a computer system, the method including the steps of:

providing in electronic form, a first book content, said book content comprising a plurality of page images which collectively form a multiple page document;

providing in electronic form, a supplemental content, said supplemental content comprising a plurality of sections;

linking the individual sections of said supplemental content with individual pages of said book content; and

accessing individual sections of said supplemental information for display, by displaying the page of the book content to which that section is linked.

According to this aspect of the invention, the book content provides a control mechanism for the display of the supplemental information. Access to the supplemental information to enable it to be displayed may be automatic or in response to a user input. If automatic, the supplemental information may be caused to be displayed on display of the linked page, or at a predetermined moment in the display phase of the page content.

The supplemental information may be stored locally to the computer system, or may be remotely stored. Further, the supplemental information may include text, graphics, sound and images.

Preferably, if the supplemental information is manually activated by user input, the user may be able to return to the linked page image at any time by a subsequent input. Where the lessons are automatically activated, the user may be prevented from returning to the display page image until such time as a predetermined portion of that section has been displayed. Further in one form, the user may not advance beyond a predetermined point in the display of the page image until such time as a predetermined portion of the supplemental information has been displayed.

This aspect of the invention has particular application to educational material, where the supplemental information may provide an ordered succession of lessons which typically are related to the subject matter of the book content. As an example, the supplemental information may be a language learning system which is embedded in a travel guide or history of the country which uses that language. In this way, the supplemental information forms a progressive lesson plan on how to speak remedial levels of the language as a user progresses through the book content.

In yet a further aspect, the present invention relates to an electronic book content programme operative to be displayed on the display surface of a computer system, the book content programme includes electronic book content comprising a plurality of page images which collectively form a multiple page document; electronic supplemental content which comprises a plurality of sections, wherein the individual sections of the supplemental content are linked to selective pages of the book content, so that in use, a user is able to access a section of the supplemental information to enable it to be displayed on the display surface, by displaying of the page image to which it relates on the display surface.

In yet a further aspect, the present invention relates to methods and systems to effectively and efficiently capture information within an electronic book content.

In accordance with this aspect of the invention, there is provided a method of compiling an item list including the steps of:

providing electronic book content which includes a plurality of page images which form a multiple page document;

displaying at least one page of said multiple page document on the display surface of a computer system;

selecting a portion of the information on the display page image; and generating at least part of the item list based on the selected information.

In a preferred form, a plurality of the pages of the electronic book content includes information which can be used to form the item list. The item list may be formed from information from a single selection or may include information from multiple selections which may be located in different pages of the electronic book or even in different electronic books. The information may be replicated directly in the generated list, or alternatively the information may be further processed so as to generate the list with specific parts of the information extracted or reordered. The nature of the processing is preferably selected as an option by a user.

This application has particular advantages for electronic book content relating to cooking and the like, where the selected information may contain recipes, food lists and the like. This compiled information can then be used to generate menus and shopping lists based on options which are available to a user.

In a particularly preferred form, the electronic book system is operative to form part of a network wherein the selected information is used as inputs to a separate system. One example is that the generated list is used to purchase products via a vendor over the Internet.

In yet a further aspect, the invention relates to an article comprising a machine readable medium having a plurality of machine readable instructions, wherein when the instructions are executed by a processor, the instructions control the display of electronic content according to any one of the methods described above.

The electronic book content and the associated application programmes according to any aspect of the invention described above, are designed so as to be run on any suitable computer platform including a personal computer, personal digital assistant, or dedicated electronic book or any combination thereof.

The electronic content data may be distributed in any suitable form such as being downloadable over a network such as the Internet to the end user device, provided on a storage device such as a CD ROM, or via continuous streaming so as enable real time viewing over a computer network. In a particularly preferred form, the content control programme to enable display of the electronic book content is bundled with the content and able to be provided by any of the above distribution techniques.

Further, to enhance the experience of the reading of electronic book content, preferably on changing page images, the display simulates the turning of a page with graphics and sound data giving the user an electronic reading experience that emulates the process of reading a paper book. The normal page sequence is predetermined by the book content although preferably users are able to read the electronic book in normal sequence or skip between pages moving forwards or backwards.

It is convenient to hereinafter describe embodiments of the present invention with reference to the accompanying drawings. It is to be appreciated that the particularity of the drawings and the related description is to be understood as not superseding the generality of the preceding broad description of the invention.

In the drawings:

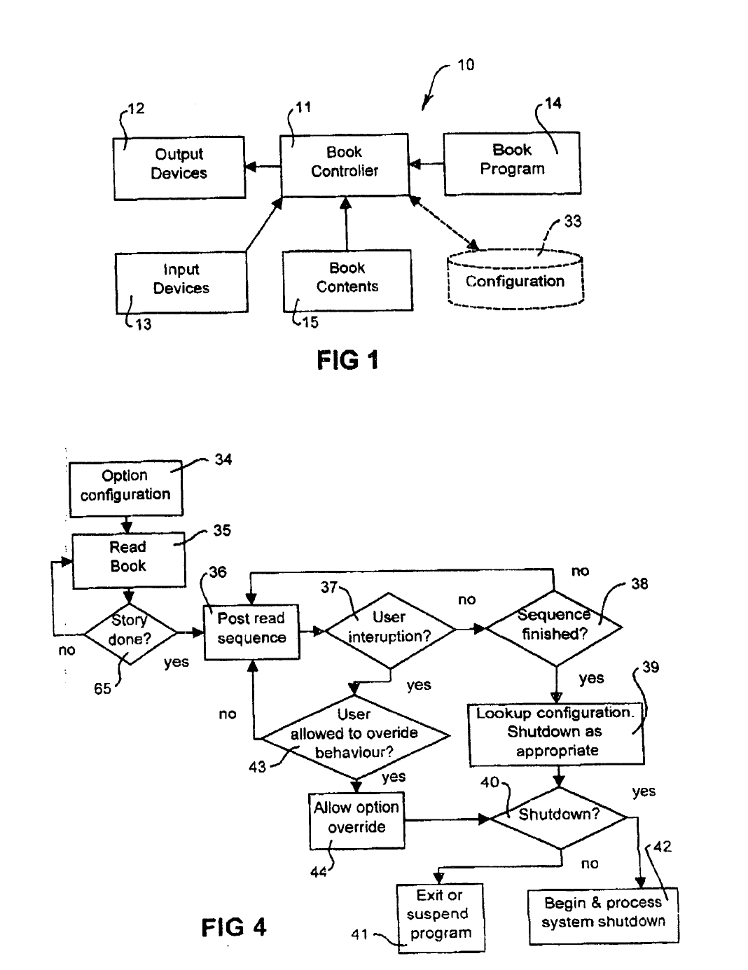

FIG. 1 is a schematic view of an electronic book system;

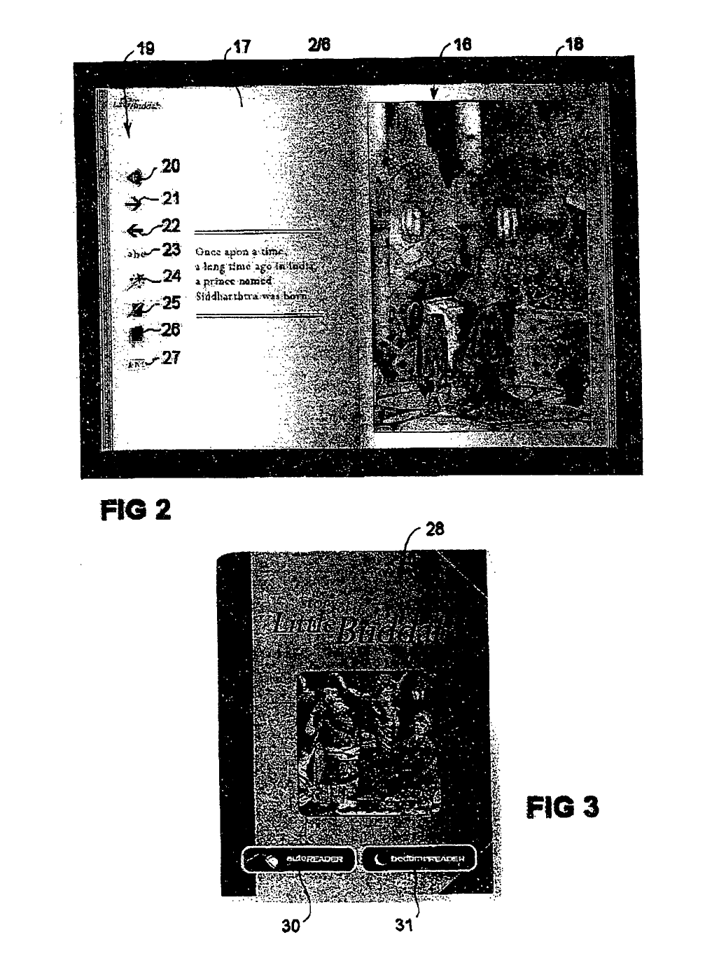

FIG. 2 is page image display of book content of the system of FIG. 1;

FIG. 3 is a cover page image display of the book content of the system of FIG. 1;

FIG. 4 is a logic flow diagram for an automatic shut down option for the system of FIG. 1;

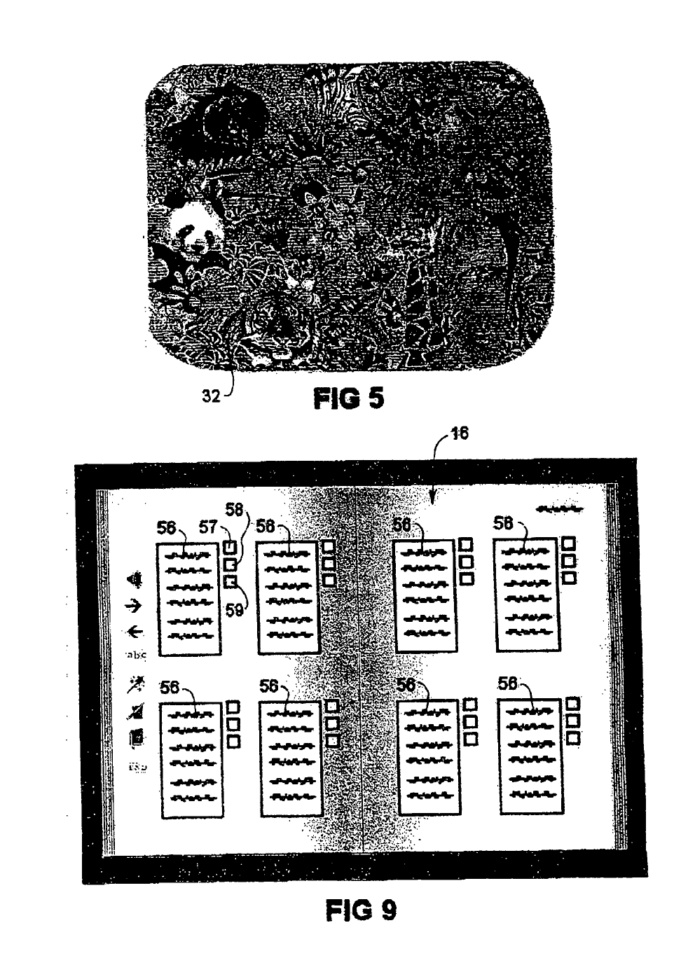

FIG. 5 is a post read sequence display for the shut down option of FIG. 4;

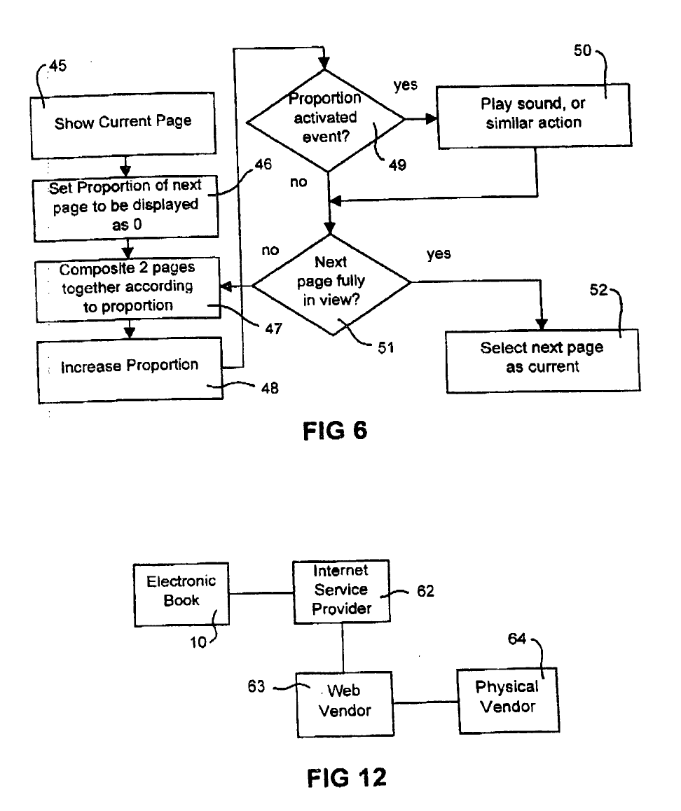

FIG. 6 is a logic flow diagram for a page turn for the system of FIG. 1;

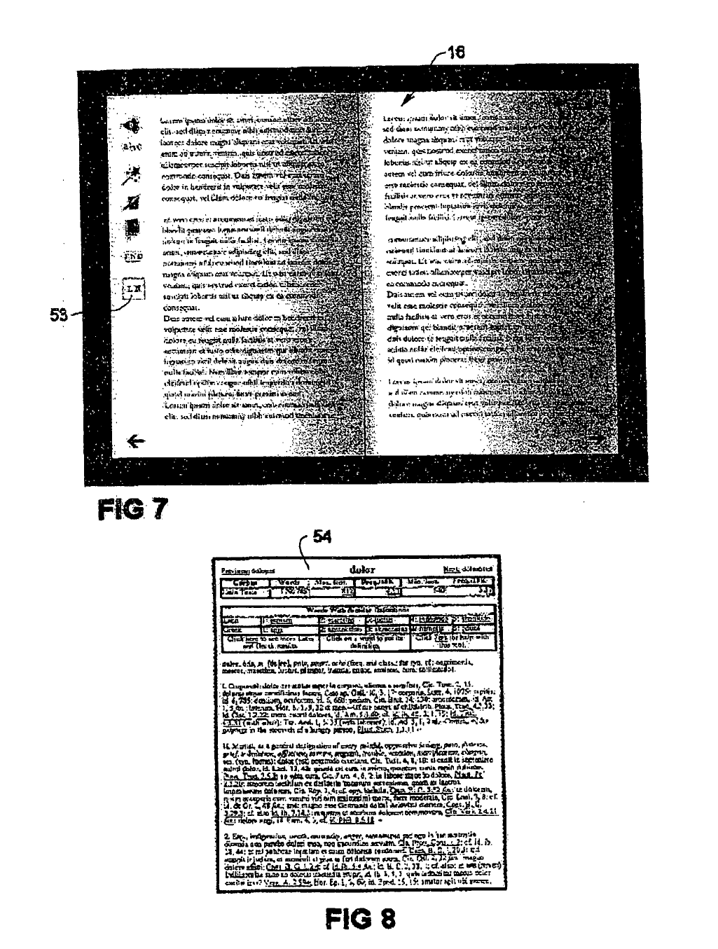

FIG. 7 is a page image display for the book content including language note option;

FIG. 8 is a display of a section of the notes of the language note option of FIG. 7;

FIG. 9 is a page image display of an electronic cookbook including a list compiling option;

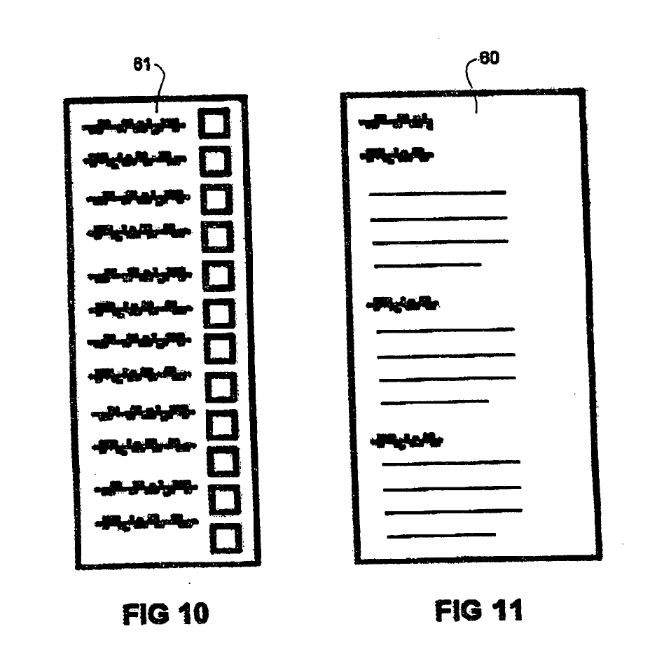

FIG. 10 is a list generated from the list compiling option of FIG. 9;

FIG. 11 is a menu generated from the list compiling option of FIG. 9; and

FIG. 12 is a functional block diagram of a grocer link option of the cookbook of FIG. 9.

Turning to FIG. 1, an electronic book system 10 includes a book controller 11 which is typically a computer or embedded controller and may take any form known in the art such as a personal computer, personal digital assistant, or dedicated electronic book display device. The book controller 11 includes an output device 12, which typically is a display surface for presentation of the contents of the book. Input devices 13 are also provided for controlling the presentation sequence of the book contents and for enabling various functions of the electronic book 10 as will be discussed in more detail below. The input devices typically include a mouse, keyboard, touch sensitive screen, electronic marker, or the like depending on the underlying book controller platform.

The electronic book 10 further includes a book programme 14 which enables the specific functions of the electronic book to be performed on the book controller 1. The book programme 14 may be a state-machine, software or logic programme. The book programme primary functions including displaying content in a variety of interactive multimedia format. Typically, standard file formats for image and sound are supported to provide interactive reading experience allowing image display, narration, sound effects, animations, mouseovers, resource libraries and lifestyle additions. These additions may include diary, games and other value added forms of entertainment. Further, the book programme allows access to onboard art packages, book marking, searching, variable display formats are also provided.

The electronic book 10 also includes book content 15 which is the data containing or representing the electronic contents. To replicate the experience of reading printed documents, the book content is structured as discrete page images 16 which provides a multiple page document which can be sequentially displayed on the output device (display) 12.

An example of a displayed page image 16 is illustrated in FIG. 2. As can be seen, the page image 16 emulates an open printed book showing two pages. In the illustrated form. one page 17 includes text whilst the opposite page 18 includes graphics which can be manipulated by a user under control of the book programme 14. Of course it will be appreciated that any similar format of text, graphics, or video may be incorporated within the scope of the page image display. Further, whilst the page image 16 emulates a double page, a single page image may also be used.

The book contents 15 can be manipulated and varied under operation of the book programme 14 by a user input using the icons 19 illustrated on the left hand side of the page image display 16. These icons include an audio option 20 where the book is narrated, navigation icons 21 and 22 which allow a user to skip between pages moving forwards or backwards, a search option 23, games 24, paint option 25 where annotated content can be coloured, a bookmark option 26 and a shut down option 27.

The following is a more substantial list of some of the options available for the electronic book system 10.

| | |
|---|---|
| Reading and Display Modes: | |
| I read | User reads a story in their own time |
| Auto read | Book narrates story to user |
| Custom | Reading options tuned to title content |
| | and audience |
| User Display | Customised book cover, interface and |
| | page delivery options |
| Language Options | Voice and text language preferences. |
| In Reading Options: | |
| Forward/Back | Advances or returns page |
| Sound On/Off | Enables or disables narrative/sound |
| | effects |
| Text On/Off | As above for text |
| Zoom | Zoom in/out |
| Pan | Pan across page |
| Font Options | Change type, colour or resize font to |
| | users preferences |
| Page Options | Alter background colour to suit |
| Mouseovers | Access embedded resources and |
| | entertainment within the book |
| Hyperlinks | Content embedded hyperlinks to custom |
| | web resources |
| Book marks | Tag pages or last page |
| Notes/Annotations | Add notes to pages or book mark |
| Search | Finds words or phrases |
| Dictionary: | Embedded dictionary related to text. |
| Print | Various content print options depending |
| | on copyright, including resource and |
| | activity prints. |
| Additional Features: | |
| Diary | Keeps a diary within the book |
| | programme for notes and ideas |
| Art work | Colour or annotate content using |
| | electronic art packages |
| Puzzle | Turn any of the favourite scenes into a |
| | jigsaw puzzle |
| Entertainment | Games, quizzes and other title based |
| | entertainment |
| Internet Support Library | Download support and special offers |
| Instructions Page | Basic instructions and help. |

A further functional feature of the electronic book 10 is the automatic shut down system best shown in FIGS. 3 to 5. As illustrated in FIG. 3, the cover page image 28 of the book contents 15 includes user input icons 30 and 31 for an auto read function and a bedtime reader function respectively. Under auto reader, the book is narrated to the user under control of the book programme 14. Under the bedtime reader 31, the book contents are narrated to a user whereafter on completion, the electronic book enters an automatic shut down procedure which incorporates a post read sequence 32 as illustrated in FIG. 5.

Under the bedtime reader option 31, the system automatically shuts down the output device 12 under operation of the book controller 11. This may occur on completion of the book content display, at a predetermined point in the display of the content, or when a predetermined set of conditions arise. The shutdown which is dependent on the configuration 33 of the book controller 11 typically places the system in a state of either being off, asleep, or in a power save mode or idle. In this way, the shutdown allows for power saving, noise minimation or elimination of any unwanted disturbances or risk caused by having the book controller in a non sleep state.

The automatic shut down occurs typically by the issuing of a request from the book programme 14 to the operating system of the book controller 11. Prior to issuing of that request, the book system is able to go through an optional post read sequence. This post read sequence consists typically of the presentation of additional book content, possibly entailing sounds, music and visual such as the display 32 shown in FIG. 5. The purpose of the additional post read may be varied. In one arrangement, the purpose of the post read sequence is to enrich the story telling reading process, or to encourage the user to enter a predetermined emotional state, in another form, the post read sequence may be to implement a secondary purpose such as to provide an ambient light which can act as a night light.

The characteristics of the post read sequence is typically able to be varied by the user through an options menu within the user interface displayed on the output device 12. The characteristics of the post read sequence 32 may include the duration, the augmentation of music or other sounds, or the intensity of the emitted display.

FIG. 4 illustrates the process of the automatic shut down option of the electronic book system 10. After the option is configured (or a default option is used) as illustrated at step 34, the book then proceeds to be read at step 35 until a predetermined action (such as the content display is complete), a terminal page has been displayed, or a nil activity time frame has expired or cue, occurs. This cue represented at step 65, prompts the sequence of events leading to either the system automatically shutting down or the programme terminating in the event that the book controller 11 does not have the functionality to automatically shut down. Prior to shut down, the system 10 enters the post read sequence at step 36. Assuming there is no user interruption 37, the system automatically proceeds to run the post read sequence as initially configured under step 34. On completion of the post read sequence at step 38, the book programme 14 then makes a request to the book controller 11 to undergo appropriate shut down (as step 39). If the book controller 11 does not support automatic shut down at step 40 the book programme is terminated at step 41. If the book controller 11 does support shut down then a request from the book programme 14 instigates shut down of the controller at step 42. If user interruption occur at step 37, then the programme functionality is then interrogated to determine whether it is a valid request at step 38 and if so overrides the post read sequence at step 39.

Example applications of the automatic shut down functionality of the electronic book 10 include a bed time reader mode for children's electronic stories, where the book narrates the story, plays four minutes of ambient sound at completion using one of the images as a bed light, then shuts the computer down, allowing the child to drift off to sleep without having to manually turn off the machine. Another example is an electronic book about meditation, where the book may take the user through a series of narrated relaxation/mediation exercises prior to shutting the system down after directing the user by sounds and images into a meditated state. Again, the automatic shut down allows the user to continue meditating long after the display device is switched off. A further option of the automatic shut down is where a user sets it to shut down if there has been no activity for 10 minutes or some pre-set time frame, hence if the user falls asleep, the book will bookmark the last page and turn the device off.

A further function of the electronic book system 10 is that it can simulate page turning and sound. Under operation of the book programme 14 on changing a page image display 16, the display simulates the turning of a page with graphic and sound data, giving the user an electronic reading experience that further emulates the process of reading a paper book. The normal page sequencing is predetermined by the content order of the book content 15, although users may read the electronic book in the normal sequence or skip between pages moving forwards or backwards under control of the navigation devices 21, 22.

An overview of the page turning process is illustrated in FIG. 6.

The content, including images and text from one page image to the next are blended with the page turn to give the impression of true transition between pages. Firstly, the current page image is displayed at step 45. A variable indicating the portion of turn between the current and next page is initialised to zero at step 46. The two page images are manipulated and composited at step 47 according to the proportion of turn. This process mimics the look of a physical book, as it appears during a page turn, as if some invisible agent turned the page. The degree of proportion of turn is increased at step 48. If the proportion matches a predefined value then a special event may be activated, at step 49 and this may be used to play a sound that matches a sound of a page being turned in a physical book at step 50 or alternatively perform some predefined action to enhance the presentation of the page turn. If the proportion matches a predefined value known as the turn completion proportion (at step 51), then the next page is selected as the current page 52, and the page turn process is completed. Otherwise, if the proportion does not match the process is repeated from the manipulation and compositing stage 47.

A further functional feature of the electronic book system 10 is the language note application illustrated in FIGS. 7 and 8. The language note application is configured to use the electronic book content 15 as a method of controlling the display of information of supplemental content. Specifically, access to the supplemental information is obtained through specific page images 16 of the book content. In the illustrated form, this access point is through a user input icon 53.

The language notes application as shown is designed to provide a language learning system which may use text, sound, narration and graphic or image based information to convey a progressive lesson plan for the learning of a language as a reader progresses through an electronic book. Whilst in the illustrated form, the language note is manually operated using icon 53, the language note facility may be automatic or manual depending on the user's preference.

With this application, once a specific page image 16 is displayed on the output device 12 of the system 10, access can then be gained to a linked supplemental information (54). In the illustrated form, the language notes application relates to specific Latin text which is relevant to the subject matter of the book content 15. The supplemental information 54 forms part of progressive lesson plan. In this arrangement, the process of presenting the lesson plan is similar to presenting other book content. Text, sounds and images are presented to the user in an orderly fashion and user input may be used to navigate through parts of the lesson. If the lesson is manually activated, at any stage it is possible to exit the lesson and return to normal electronic book operation. If the lessons are automatically activated, it may be desired that the user cannot continue past the trigger in the book that invoked the lesson, until such time as they have successfully completed the lesson.

Under operation of the language note option, it enables a user as they progress through the electronic book content 15 to also progress through the supplemental information in an ordered way, thereby providing a method of both controlling and structuring information presented to the user.

FIGS. 9 to 11 illustrate further optional functionality of the electronic book system 10. This aspect of the system 10 is to enable enhanced effective and efficient capture of information within the electronic book content.

A cookbook is illustrated in FIG. 9 which incorporates this functionality. However it is to be appreciated that this functionality is equally applicable to other subject matter.

As illustrated in FIG. 9, the page image display 16 incorporates a number of recipes 56. Each recipe has associated with it user input icons 57, 58 and 59. Each of these icons allows information specific to the recipe to which it relates to be manipulated under operation of the book controller 14. In the illustrated form, item 57 is a favourites option allowing the menu to be stored in a separate list as a favourite, icon 58 relates to a menu listing where the recipe is incorporated on a menu list (as illustrated in FIG. 11).

Item 59 is an ingredients listing wherein the ingredients detailed in the recipe are incorporated as part of an ingredients list as illustrated in 61 in FIG. 10.

Under operation of this system, a user selects a particular recipe by registering on either of the icon 47, 58, 59 which is particular to that recipe. The book controller then incorporates the recipe as part of a menu 60 or alternatively uses the ingredients incorporated with the recipe to be included on the ingredients list 61.

Once the generated list 60 or 61 are completed, they may be printed, compiled or otherwise used.

One option for use of the generated lists is illustrated in FIG. 12. In that application, the generated list 61 can be used directly as an input purchase for an online vendor. In this arrangement, the list 61 provides an input to the web vender 63 which is typically done through an internet service provider 62. Once the purchase is placed with the web vender 63, the items can then be delivered by a physical vender 64.

Accordingly, the present invention provides electronic book systems which have advanced functionality enabling enhanced user experiences through manipulation of content display and interaction with associated parts of the electronic book systems.

It will be appreciated that modifications or additions may be made to the parts and arrangement previously described without departing from the spirit or ambit of the invention.

1. A method of controlling the display of electronic book content on a display surface under operation of a content control programme, said book content including a plurality of page images which form a multiple page document and said display surface being capable of adopting an active mode where information can be displayed, and an inactive mode where the surface is substantially passive, said method including the steps of:
displaying at least one of said pages on said display surface whilst in its active mode;
generating a shut down request without requiring user intervention; and
rendering the display surface inactive in response to said shut down request.

2. A method according to claim 1, wherein said shut down request is generated in response to a state associated with the display on said display surface.

3. A method according to claim 2, wherein said state is selected from the group comprising:
completion of display of the book content;
1 display of a terminal page;
expiration of a nil activity time frame.

4. A method according to claim 3, wherein said shut down request is generated in response to the display of a terminal page, and the method further including the step of establishing a page of said book content as being said terminal page prior to display of that page.

5. A method according to any preceding claim, further including the step of displaying a post read sequence prior to rendering the display surface inactive.

6. A method according to claim 5, wherein said post read sequence includes images and/or audio.

7. A method according to either claim 5 or 6, further including the step of establishing at least one characteristic of said post read sequence prior to display of said sequence.

8. A method according to claim 7, wherein the at least one characteristic of said post read sequence is selected from the group comprising:
the specific images displayed;
the intensity of the display and
the duration of the post read sequence.

9. An article comprising:
a machine readable medium having a plurality of machine readable instructions, wherein when the instructions are executed by a processor, the instructions control the display of electronic book content on a display surface according to a method as claimed in any one of claims 1 to 8.

10. A book content programme for displaying information on a computer system including a display surface, the display surface being operative to adopt an active mode, where information can be displayed, and an inactive mode where the surface is substantially passive, the programme including electronic book content which includes a plurality of page images which form a multiple page document, and a controller including a content control component to control the display of pages on the display surface, and a display control component which is operative to request the computer system to change said display surface from said active mode to said passive mode, wherein the programme is configured so that the display control component is operative without user intervention to issue said request to said computer system to change from said active mode to said passive mode after at least one page has been displayed on said display surface under control of the content control component.

11. A book content programme according to claim 10, wherein the display control component is able to be selectively enabled and disabled by a user input, and wherein the programme further includes an input component for allowing a user to enable said display control component prior to the display of said pages under control of the content control component.

12. A book content programme according to either claim 10 or 11, wherein the book content further includes a post read sequence content, the post read sequence content being operative to be displayed on said display surface under operation of the content control component, and wherein the post read sequence is operative to be displayed following display of the at least one page, and prior to operation of the display control component to render the display screen inactive.

13. A book content programme according to any of claims 10 to 12, wherein the at least one characteristic of the post read content sequence is able to be configured by a user.

14. A book content programme according to claim 13, wherein the at least one characteristic of the post read sequence content is selected from the group comprising:
the specific images displayed;
duration of the post read sequence;
the existence of other content;
the intensity of the display.

15. A method of controlling the display of information on a display surface of a computer system, the method including the steps of:
providing in electronic form, book content, said book content comprising a plurality of page images which collectively form a multiple page document;
providing in electronic form, supplemental content, said supplemental content comprising a plurality of sections;
linking the individual sections of said supplemental content with individual pages of said book content; and
accessing individual sections of said supplemental information for display by displaying the page of the book content to which that section is linked.

16. A method according to claim 15, wherein the individual sections of said supplemental information are accessed in response to a user input.

17. A method according to claim 15, wherein the supplemental information is caused to be displayed in response to the display of the page to which that supplemental information is linked.

18. A method according to any one of claims 15 to 17, wherein the display of at least one of the pages of the book content is dependent on the display of at least one individual section of the supplemental content.

19. An article comprising:
a machine readable medium having a plurality of machine readable instructions, wherein when the instructions are executed by a processor, the instructions control the display of information on a display surface according to a method as claimed in any one claims 15 to 18.

20. A book content software programme operative to be displayed on the display surface of a computer system, the book contents programme including electronic book content comprising a plurality of page images which collectively form a multiple page document, and electronic supplemental content which comprises a plurality of sections, wherein the individual sections of the supplemental content are linked to selective pages of the book content so that in use, a user is able to access a section of the supplemental information to enable it to be displayed on the display surface by displaying the page image to which it relates on the display surface.

21. A method of compiling an item list including the steps of:
providing electronic book content which includes a plurality of page images which form a multiple page document;
displaying at least one page of said multiple page document on the display surface of a computer system;
selecting a portion of the information on the display page image; and
generating at least part of the item list based on the selected information.

22. An article comprising:
a machine readable medium having a plurality of machine readable instructions, wherein when the instructions are executed by a processor, the instructions compile an item list according to a method as claimed in claim 21.
